(19) United States
(12) Patent Application Publication
(10) Pub. No.: US 2005/0194212 A1
(43) Pub. Date: Sep. 8, 2005

(54) Support device for use in the building and maintenance of sloping roofs

(76) Inventors: James Board, Camber Sands (GB); James Anthony Board, Bexleyhheath (GB)

Correspondence Address: STITES & HARBISON PLLC, 1199 NORTH FAIRFAX STREET, SUITE 900, ALEXANDRIA, VA, 22314, US

(21) Appl. No.: 10/790,681

(22) Filed: Mar. 3, 2004

(51) Int. Cl. E06C 7/00

(52) U.S. Cl. 182/45

(57) ABSTRACT

The device comprising a support member (10) connected to a base (12) by a joint (18), and at least one support arm (14, 16) extending between the support member (10) and the base (12) at a location remote from the joint (18). A rung-engaging element (20) is carried by the base (12) and extends in a direction away from the support member (10) to engage the rungs (22) of a roof ladder (24). The support member (10) has a support surface (46) which in use lies in a generally horizontal plane while the base (12) lies generally adjacent and parallel to the plane of the roof (26).

### FIELD OF THE INVENTION

The invention relates to a support device for use in the building and maintenance of sloping roofs.

### BACKGROUND OF THE INVENTION

When building or maintaining a sloping roof formed, for example, of tiles or slates, the worker needs to store his tools, roofing materials and removed roofing materials somewhere close to hand. It is inconvenient for the worker to have to repeatedly move away from his area of work for these items. Where the work involved is so substantial that a scaffolding structure is used, then tools and roofing materials can be stored on horizontal surfaces attached to such a structure, such as scaffolding planks. However, for smaller scale jobs where a scaffolding structure is not used, or where the roof is so large that the worker is working some distance from the scaffolding structure, there is a need for a support device upon which tools and roofing materials can be stored close to the area of work.

### SUMMARY OF THE INVENTION

According to the invention, there is provided a support device for use in the building and maintenance of sloping roofs, comprising a support member connected to a base by a joint, at least one support arm extending between the support member and the base at a location remote from the joint, and a rung-engaging element carried by the base and extending in a direction away from the support member to engage the rungs of a roof ladder, whereby in use the support member has a support surface lying in a generally horizontal plane while the base lies generally adjacent and parallel to the plane of the roof, wherein the rung-engaging element is located along one edge of the base and comprises a plurality of spaced cut-outs each so shaped to engage a rung of a roof ladder, and further comprising an elongate roof-engaging foot, located along an edge of the base opposite to the rung-engaging element.

Thus the invention provides a device which has a horizontal support surface upon which tools and roofing materials can be stored. The device can be retained in place by engagement of the rung-engaging element with a roof ladder. Since the roof ladder will generally be securely positioned on the roof, in a known manner, for example by having a hooked upper end which engages the ridge of the roof, the support device is also secure.

The rung-engaging element is located along one edge of the base, and includes a plurality of spaced cut-outs each so shaped to engage a rung of a roof ladder. This feature takes advantage of the fact that most ladders have a standard spacing between the rungs. It is preferred that the rung-engaging element engages at least two rungs of the ladder, to maximize stability. In one embodiment of the invention, the base is integral with the rung-engaging element and is formed by folding a blank having the spaced cut-outs preformed therein.

An elongate roof-engaging leg is located along an edge of the base opposite to the rung-engaging member. Conveniently, this roof-engaging leg may be of similar construction to the rung engaging element, so enabling the device to be mounted to the left or to the right of the roof ladder, according to preference. The leg may carry a roof-engaging foot, the position of which can be adjusted towards and away from the roof.

The joint connecting the support member and the base may be in the form of a hinge. The support member may be hinged to the base about a hinge axis which lies adjacent one edge of the base and/or the support member. Also, the arms are preferably hinged to the support member and releasably engageable with the base, or vice versa. These features enable the device to be collapsible. By adopting a collapsible construction, it is easier for the worker to carry the device up to and down from the roof. Also, by hinging the arms to the support member or to the base, it is possible to orientate the arm into a substantially vertical position in use, to maximize the stability of the device.

In use, when the roof ladder is located on a sloping roof, the support member has a support surface lying in a generally horizontal plane while the base lies generally adjacent and parallel to the plane of the roof. To enable this to be achieved when working on roofs of different pitches, the arms preferably have an adjustable length, for example by having a telescopic construction. This enables the orientation of the support member to be adjusted into a horizontal position. It is useful for the support member to incorporate a level-indicating device, such as a spirit level.

The base and the support member are preferably of generally planar configuration. The support member may optionally include shaped holes for the secure retention of tools, and a vice to hold roofing material which needs to be worked on before being put in place. In one embodiment of such a vice, a plate-shaped member is hinged to one side edge of the support member and can be folded over into face-to-face relationship with the support surface of the support member to enable roofing material, such as lead sheeting, to be trapped there-between enabling the material to be conveniently worked prior to being located on the roof. An upwardly extending rim of the support member may also be provided to prevent items falling off the support surface.

In addition to the rung-engaging element, the base may be provided with means whereby additional support means may be attached thereto. For example, one or more telescopic hooks of tubular configuration can be provided and attached to the base by the use of U-bolts passing through holes in the base, the support hooks being extended to hook over the ridge of the roof.

The support device according to the invention may be formed of any materials of suitable strength. In particular, it is preferable to form the device of a light weight material such as aluminum or a plastics material, although other materials such as wood could also be used.

The invention will now be further described, purely by way of example, with reference to the accompanying drawings, in which:

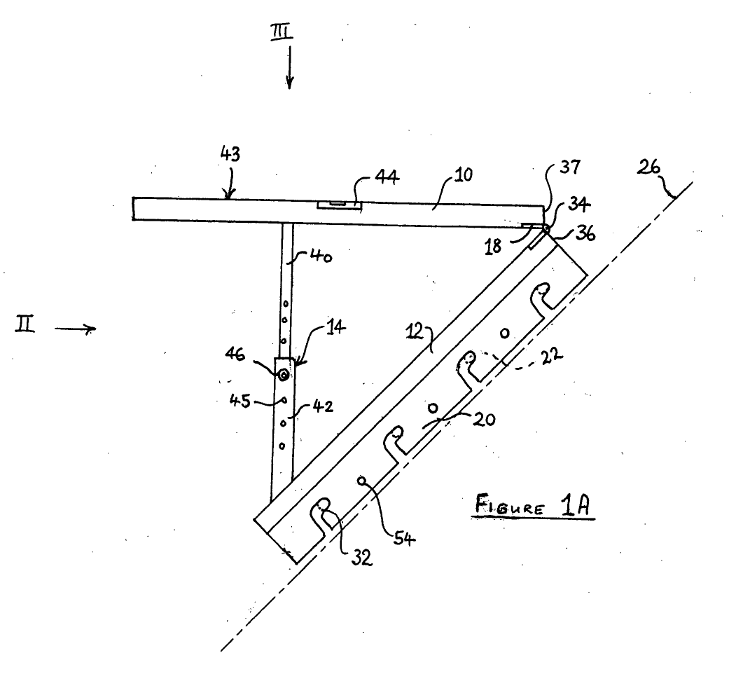

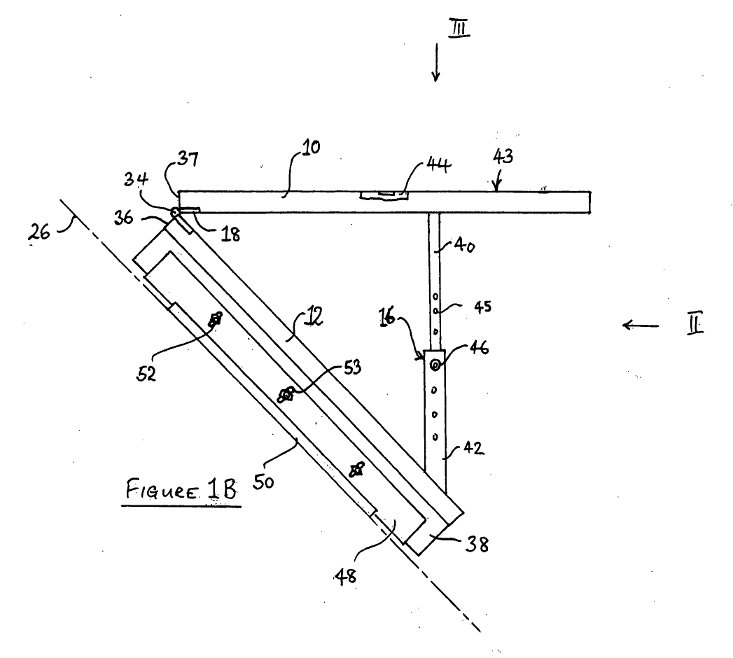

FIGS. 1A and 1B are a diagrammatic representations of a support device according to the invention, viewed from one side and the other side respectively;

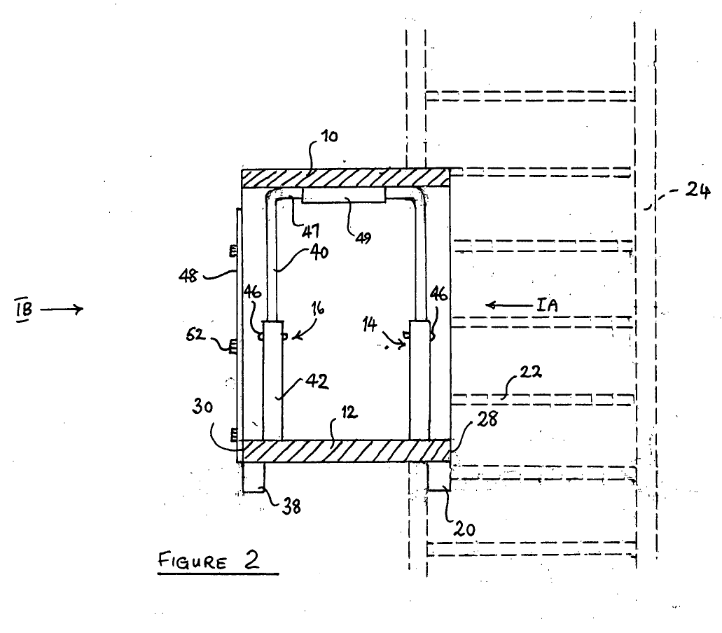

FIG. 2 is a view of the support device shown in FIG. 1, viewed from the direction II in FIG. 1;

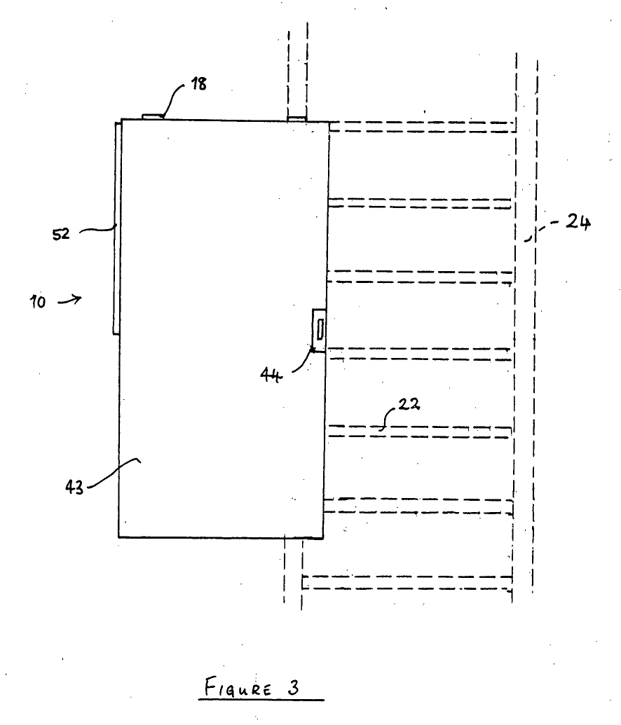

FIG. 3 is a view of the support device shown in FIG. 1, viewed from the direction III in FIG. 1; and

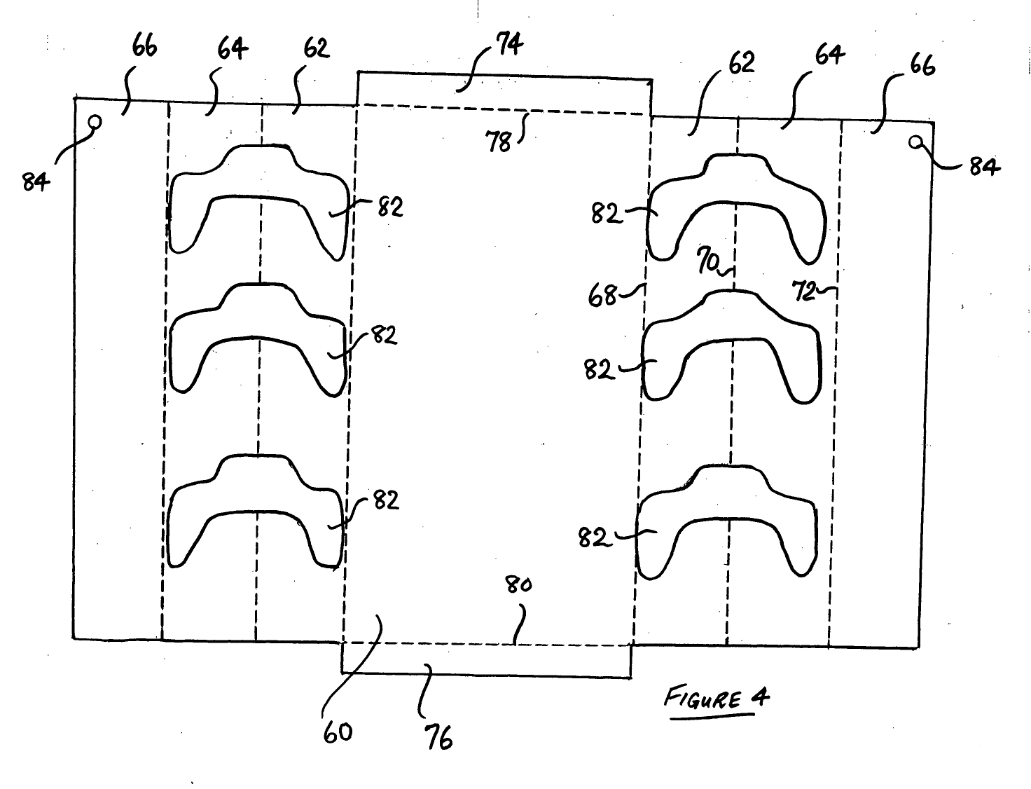

FIG. 4 shows a cut out blank which can be used to form the base of a modification of the support device shown in FIGS. 1A, 1B and 2.

The drawings show a collapsible support device for use in the building and maintenance of a sloping roof 26. The support device comprises a support member 10 of generally rectangular planar configuration hinged to a base 12, also of generally rectangular planar configuration. The support member 10 is hinged to the base 12 by a hinge 18 to open and close about a hinge axis 34 which lies along the top edge 36 of the base 12 and the end edge 37 of the support member 10.

Two telescopically adjustable support arms 14, 16 extend between the support member 10 and the base 12 at a location remote from the hinge 18. The arms 14, 16 are hinged to the support member 10 and releasably engageable with the base 12. Each arm 14, 16 consists of a lower cylindrical part 42, hinged to the base 12, within which an upper square cross-sectional part 40 slides, the two upper arm parts 40 being formed as a single U-shaped member, the cross piece 47 of which engages releasably with a clip 49 carried by the support member 10. Although only one such clip 49 is shown, a number of such clips could be provided, each in an optimum position for use with a roof of a given pitch, such as 30°, 45° and 60°.

The upper and lower parts of the arms 14, 16 have spaced holes 45, through which a locking peg 46 may be inserted, to lock the arm in a position of desired length.

A rung-engaging element 20 is located along one edge 28 of the base 12 and extends in a direction away from the support member 10. The rung-engaging element 20 includes a number of spaced cut-outs 32 each so shaped to engage a rung 22 of a roof ladder 24.

An elongate roof-engaging leg 38 is located along a side edge 30 of the base 12 opposite to the rung-engaging element 20. The leg 38 in the illustrated embodiment has the same construction as the rung-engaging member 20, so that the device may be positioned on the right side of the ladder 24 as viewed in FIGS. 2 and 3, instead of the left hand side thereof, if so desired. The leg 38 has a side piece 48 bolted thereon by bolts 52 which pass through apertures 53 in the side piece 48 and apertures 54 in the leg 38. The side piece 48 carries a roof-engaging foot 50. The apertures 53 in the side piece 48 are in the form of slots, enabling the foot 50 to be adjusted towards or away from the roof 26. In this manner the most stable position for the device on the roof may be found.

In use, the support surface 43 of the support member 10 lies in a generally horizontal plane while the base 12 lies generally adjacent and parallel to the plane of the roof 26. The support member 10 incorporates a spirit level 44, to indicate to the user when the support surface 46 is horizontal.

Although not shown as such in FIGS. 1A, 1B, 2 and 3, the support member 10 and the base 12 may be constructed with side members so that when the device is collapsed a hollow box-like configuration is achieved, with the collapsed arms 14, 16 located inside the box.

FIG. 4 shows a blank from which a base for a modified embodiment of a support device according to the invention can be partly constructed. In this embodiment, the base is integral with the rung-engaging element and is formed by folding a blank having the spaced cut-outs preformed therein. More specifically, the blank is formed of metal, plastics or other suitable foldable material and comprises a main rectangular panel 60, having three elongate side panels 62, 64, 66 attached thereto on either side, the panels being separated by folds 68, 70, 72 as indicated by broken lines. Also top and bottom panels 74, 76 are formed, separated from the main panel 60 by folds 78, 80.

Cut outs 82 are formed in the side panels 62, 64 and are so shaped that when side panels 62 and 64 are folded towards the viewer of FIG. 4 into face-to-face relationship with each other, rung engaging cut-outs similar to the cut-outs 32 of FIGS. 1A, 1B, 2 and 3 are formed.

Side panels 66 and top and bottom panels 74, 76 are folded away from the viewer to form side walls of a box-like base, to which other components of the support device can be connected. Apertures 84 in the side panels 66 form the support for a hinge bar of a hinge such as hinge 18 of the previous embodiment by which a support member is connected to the base.

1. A support device for use in building and maintenance of a roof having a sloping plane, for use with a roof ladder having rungs, said support device comprising
a support member connected to a base by means of a joint,
at least one support arm extending between said support member and said base at a location remote from said joint, and
a rung-engaging element carried by said base and extending in a direction away from said support member to engage said rungs of said roof ladder,
whereby in use said support member has a support surface lying in a generally horizontal plane while said base lies generally adjacent and parallel to said plane of said roof,
wherein said rung-engaging element is located along a first lower edge of said base and comprises a plurality of spaced cut-outs each so shaped to engage a rung of a roof ladder, and
further comprising an elongate roof-engaging leg which is adjustably attached to a second lower edge of said base opposite to said rung-engaging element so as to be adjusted toward or away from the roof.

2. The support device of claim 1, which is collapsible and in which said at least one support arm is hinged to said support member and is releasably engageable with said base.

3. The support device of claim 1, wherein said at least one support arm has an adjustable length.

4. The support device of claim 1, wherein said support member incorporates a level-indicating device.

5. The support device of claim 1, wherein said base is of generally planar configuration.

6. The support device of claim 1, wherein said support member is of generally planar configuration.

7. The support device of claim 1, wherein said support member is jointed to said base about a joint axis which lies adjacent one edge of said base.

8. The support device of claim 1, wherein said support member is jointed to said base about a joint axis which lies adjacent one edge of said support member.

9. The support device of claim 1, wherein said base is integral with said rung-engaging element and wherein said first and second lower edges are each is formed by folding together two side panels of a blank where said side panels have said plurality of spaced cutouts preformed therein.

10. The combination of the support device of claim 1 and a roof ladder, said rung-engaging element engaging said rungs of said roof ladder, whereby in use, when said roof ladder is located on a sloping roof, said support member has a support surface lying in a generally horizontal plane while said base lies generally adjacent and parallel to said plane of said roof.
